(19) United States
(12) Patent Application Publication
(10) Pub. No.: US 2003/0201303 A1
(43) Pub. Date: Oct. 30, 2003

(54) Modified aperture for surface mount technology (SMT) screen printing

(76) Inventors: Heidi N. Jones, Corrales, NM (US); Scott A. Welle, Albuquerque, NM (US)

Correspondence Address: HONEYWELL INTERNATIONAL INC., 101 COLUMBIA ROAD, P O BOX 2245, MORRISTOWN, NJ, 07962-2245, US

(21) Appl. No.: 10/387,179

(22) Filed: Mar. 11, 2003

Related U.S. Application Data
(60) Provisional application No. 60/375,090, filed on Apr. 24, 2002.

(51) Int. Cl. B23K 31/00; B23K 37/00

(52) U.S. Cl. 228/41; 228/248.1; 228/248.5

(57) ABSTRACT

A modified aperture shape for screen printing eliminates insufficient solder without increasing the number of solder bridges. The shape is narrow in the area where the component lead will touch and wide or overprinted in the area where the lead does not touch. To further increase solder volume the length of the aperture can also be overprinted. The overprinted areas provide greater solder volume, while the narrow area where the lead will touch prevents solder bridging.

### CROSS-REFERENCE TO RELATED APPLICATIONS

This application is based on a provisional application, U.S. Provisional Application Serial No. 60/375,090, entitled “Modified Aperture for Screenprinting”, filed on Apr. 24, 2002, the teachings of which are incorporated herein by reference.

### BACKGROUND OF THE INVENTION

1. Field of the Invention (Technical Field)

The screen or stencil printing process of the electronics manufacturing industry, and more particularly in the field of screen printed apertures for soldering surface mounted components on a circuit card.

2. Background Art

A typical prior art pad configuration 110 is shown in FIG. 1. The standard shape for screen printing apertures is a rectangular shape, as shown. The usual dimensions for an aperture are a width of 9.65 Mils and length of 64.95 Mils for total surface area of 623.52 Mils². Using the prior art embodiment, an unacceptable number of defects are being produced on solder joints in the surface mount technology (SMT) area. A large percentage of these defects are due to circuit card assemblies with fine pitch components (<20 Mil pitch) that have an insufficient amount of solder during the reflow process. The molten solder paste wicks (flows) up the lead of the fine pitch SMT component creating an insufficient heel fillet per IPC-A-610, Class 3. Typically the industry solution has been to overprint the pads or using an aperture larger than the pad in both a width dimension and length dimension. FIG. 2 is a drawing of a pad and aperture using the “industry standard” approach of overprinting. A standard aperture 110 is shown inside the overprinted aperture 114 in dotted lines. Shown is a 15% overprint to achieve maximum solder volume, however, this percentage can vary. The dotted line represents the current/normal pad design and the solid line represents the 15% overprint. This technique has been unsuccessful due to the resulting large amount of solder bridges between the leads. Shorts are caused by displacement of the solder paste when the component lead is placed on the pad. If the paste from two adjacent pads is in contact before solder reflow, a bridge usually results. Other unsuccessful techniques that have been attempted are: overprinting the pad in one direction only, thus making the aperture longer than the pad but not wider; using a thicker stencil, thus increasing the foil thickness; and using a step stencil, thus increasing the foil thickness in the area where greater volume is required.

The shortcomings of each of the state of the prior art approaches are as follows: overprinting the pads leads causes solder bridges; overprinting the pad in one direction only does not always provide enough solder volume and using a thicker stencil or using a step stencil does not always provide enough solder volume. As the area ratio decreases, paste release becomes an issue.

The present invention reduces the width of the paste deposit in the area where the component lead will be placed, and increases the paste deposit width where it will not touch. The solder paste deposit is not displaced by the component lead, thus avoiding solder bridges.

### SUMMARY OF THE INVENTION (DISCLOSURE OF THE INVENTION)

In accordance with the present invention, there is disclosed an aperture for depositing solder paste for mounting a component lead on a circuit card assembly comprising a first width dimension comprising a first portion of a length dimension and a second width dimension, the second width dimension being less than the first width dimension and comprising a second portion of the length dimension, wherein the second width dimension comprises a lead touching area. The apparatus further comprises at least one transition taper between the first width dimension and the second width dimension. The apparatus can further comprise at least one transition curve between the first width dimension and the second width dimension. The first portion of a length dimension preferably comprises one-half of a total length dimension. The first portion of a length dimension can comprise a first predetermined dimension and a second predetermined dimension and the second width dimension is between the first predetermined dimension and the second predetermined dimension. The first width dimension and said second width dimension can comprise tapered width dimensions. The first width dimension preferably comprises nine (9) Mils, the second width dimension comprises eleven (11) Mils and the length dimension comprises ninety (90) Mils.

The preferred aperture for depositing solder paste for mounting a component lead on a circuit card assembly comprises a first predetermined surface area and a second predetermined surface area, wherein the second predetermined surface area is less than the first predetermined surface area and the second predetermined surface area comprises a lead touching area. The apparatus can further comprise at least one transition taper between the first predetermined surface area and the second predetermined surface area. The apparatus can further comprise at least one transition curve between the first predetermined surface area and the second predetermined surface area. The first predetermined surface area can comprise 522.5 Mils² and the second predetermined surface area can comprise 427.5 Mils².

A primary object of the present invention is to provide an aperture that prevents solder bridges where the leads of the components touch the solder paste.

Another object of the present invention is to provide an increase in solder volume.

One advantage of the invention is that is provides a greater volume in the paste deposit.

Another advantage is that it does not result in a greater number of solder bridges.

Yet another advantage is that the present invention saves money by reducing rework from insufficient solder and repairing solder bridges.

Another advantage is that the invention is easily used/substituted by stencil manufacturers and it can be manufactured using their current process.

Other objects, advantages and novel features, and further scope of applicability of the present invention will be set forth in part in the detailed description to follow, taken in conjunction with the accompanying drawings, and in part will become apparent to those skilled in the art upon examination of the following, or may be learned by practice of the invention. The objects and advantages of the invention may be realized and attained by means of the instrumentalities and combinations particularly pointed out in the appended claims.

### BRIEF DESCRIPTION OF THE DRAWINGS

The accompanying drawings, which are incorporated into and form a part of the specification, illustrate several embodiments of the present invention and, together with the description, serve to explain the principles of the invention. The drawings are only for the purpose of illustrating a preferred embodiment of the invention and are not to be construed as limiting the invention. In the drawings:

FIG. 1 shows a prior art aperture for screen printing.

FIG. 2 is another prior art embodiment using an overprinting technique.

FIG. 3 depicts the preferred modified aperture for screen printing.

FIG. 4 shown the variable dimensions used to optimize the preferred new aperture.

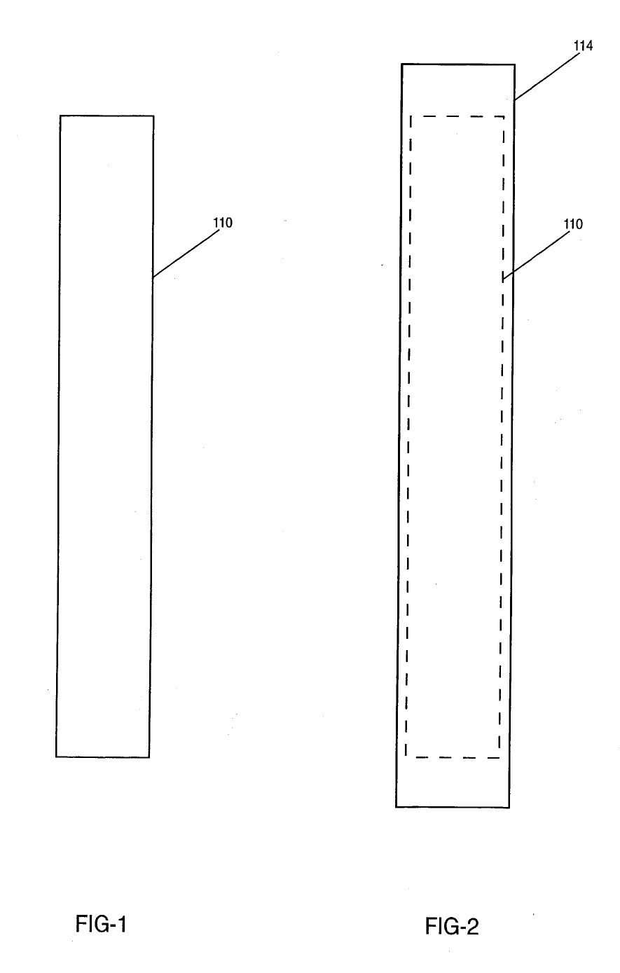

### DESCRIPTION OF THE PREFERRED EMBODIMENTS (BEST MODES FOR CARRYING OUT THE INVENTION)

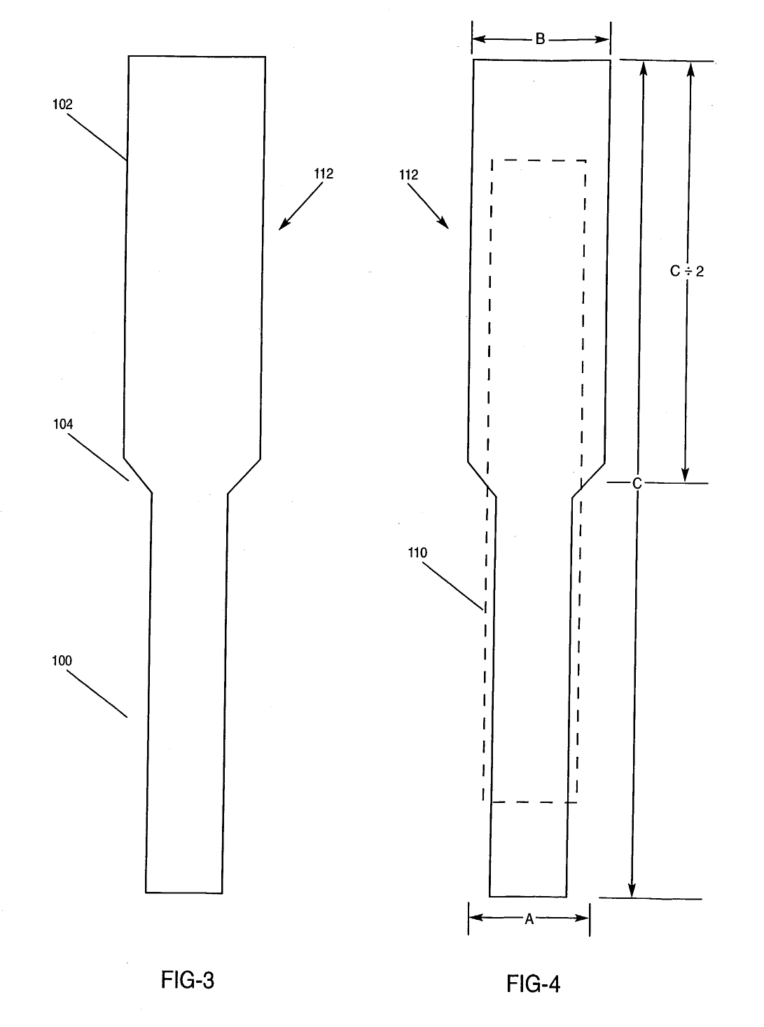

The preferred modified aperture shape 112, as shown in FIG. 3, is employed to provide optimal solder volume without causing bridges. The aperture is narrow in the area where the lead will touch 100, and wider where it will not touch 102. The construction of the stencil itself is optional. Any method such as laser cut, chemical etch, electroform, etc. to create the aperture can be employed. The narrow area 100 where the component lead will touch prevents bridging. The larger area 102 provides for greater volume. The transition areas 104 between the narrow area 100 and the wider area 102 are preferably tapered, as shown. Other types of transitions can be used such as a curve or partial circle. The different types of transitions are for ease of cutting and removing the unneeded foil. Using this embodiment, the two areas form a paste deposit with greater solder volume that does not bridge to adjacent solder joints. Other alternative shapes could be used to accomplish the same benefits. These can include an hourglass shape or wedge shape (not shown). These shapes can also provide a narrow width where the lead will touch and a wider width where the lead does not touch for increased solder volume.

The preferred dimensions were optimized for the new aperture design by lab tests. FIG. 4 shows the dimensions that were varied to optimize the new aperture shape. Dimension A represents narrow width dimension, B is the wider width dimension and C is the length dimension. A normal prior art aperture 110 is superimposed over the newly designed aperture 112 for comparison. Below is a table of the dimensions used to optimize the new design. The screens can be manufactured using the standard process, in the present case, 6 Mil stainless foils, laser cut with an electropolish finish were used. Note that the dimensions can be modified and are dependent on the lead sizes and dimensions, or the pitch and width of the component lead, the component and circuit card configuration, the placement pressure and the viscosity of the paste. However, the same basic configuration of the aperture, as described above, can be used for all of these variables. The preferred dimensions for the new aperture are: A 9 Mils, B 11 Mils and C 95 Mils, as shown in Table 1 below. In addition, Table 1 contains information regarding a standard aperture and a prior art overprinted aperture.

TABLE 1
SOLDER PASTE VOLUME EXPERIMENT

| | | | | | | SOLDER | RELATIVE |
|---|---|---|---|---|---|---|---|
| APERTURE | WIDTH | WIDTH 2 | LENGTH | AREA | PASTE VOLUME | VOLUME | VOLUME |
| −10% | 8.64 | n/a | 58.46 | 505.05 | 3030.31 | 1515.15 | 0% |
| 1:1 Pad | 9.60 | n/a | 64.95 | 623.52 | 3741.12 | 1870.56 | 23.46% |
| +15% | 11.04 | n/a | 74.69 | 824.61 | 4947.63 | 2473.82 | 63.27% |
| Custom 3 | 11.04 | 12.00 | 80.95 | 932.54 | 5595.26 | 2797.63 | 84.64% |
| Custom 1 | 9.00 | 11.00 | 95.00 | 950.00 | 5700.00 | 2850.00 | 88.10% |
| Custom 4 | 12.00 | n/a | 81.19 | 974.25 | 5845.50 | 2922.75 | 92.90% |
| Custom 2 | 11.04 | 12.00 | 84.95 | 978.62 | 5871.74 | 2935.87 | 93.77% |

Although the invention has been described in detail with particular reference to these preferred embodiments, other embodiments can achieve the same results. Variations and modifications of the present invention will be obvious to those skilled in the art and it is intended to cover in the appended claims all such modifications and equivalents. The entire disclosures of all references, applications, patents, and publications cited above, are hereby incorporated by reference.

What is claimed is:

1. An aperture for depositing solder paste for mounting a component lead on a circuit card assembly, the invention comprising:
a first width dimension comprising a first portion of a length dimension; and
a second width dimension, said second width dimension being less than said first width dimension and comprising a second portion of the length dimension, wherein said second width dimension comprises a lead touching area.

2. The invention of claim 1 further comprising at least one transition taper between said first width dimension and said second width dimension.

3. The invention of claim 1 further comprising at least one transition curve between said first width dimension and said second width dimension.

4. The invention of claim 1 wherein said first portion of a length dimension comprises one-half of a total length dimension.

5. The invention of claim 1 wherein said first portion of a length dimension comprises a first predetermined dimension and a second predetermined dimension and said second width dimension is between the first predetermined dimension and the second predetermined dimension.

6. The invention of claim 1 wherein said first width dimension and said second width dimension comprise tapered width dimensions.

7. The invention of claim 1 wherein said first width dimension comprises nine (9) Mils, said second width dimension comprises eleven (11) Mils and said length dimension comprises ninety (90) Mils.

8. An aperture for depositing solder paste for mounting a component lead on a circuit card assembly comprising:
a first predetermined surface area; and
a second predetermined surface area, wherein said second predetermined surface area is less than said first predetermined surface area and said second predetermined surface area comprises a lead touching area.

9. The invention of claim 8 further comprising at least one transition taper between said first predetermined surface area and said second predetermined surface area.

10. The invention of claim 8 further comprising at least one transition curve between said first predetermined surface area and said second predetermined surface area.

11. The invention of claim 8 wherein said first predetermined surface area comprises 522.5 Mils² and said second predetermined surface area comprises 427.5 Mils².
